(19) United States
(12) Patent Application Publication
(10) Pub. No.: US 2017/0229244 A1
(43) Pub. Date: Aug. 10, 2017

(54) MULTILAYER CERAMIC CAPACITOR

(71) Applicant: Murata Manufacturing Co., Ltd., Nagaokakyo-shi (JP)

(72) Inventors: Hirotaka NAKAZAWA, Nagaokakyo-shi (JP); Takashi SAWADA, Nagaokakyo-shi (JP)

(21) Appl. No.: 15/427,123

(22) Filed: Feb. 8, 2017

(30) Foreign Application Priority Data
Feb. 9, 2016 (JP) 2016-022549

(51) Int. Cl. H01G 4/30; H01G 4/12; H01G 4/232; H01G 4/012

(52) U.S. Cl. CPC H01G 4/30; H01G 4/012; H01G 4/1227; H01G 4/1236; H01G 4/2325

(57) ABSTRACT

A multilayer ceramic capacitor includes a capacitor body including a first internal electrode laminated portion in which three or more first internal electrodes are laminated in a laminating direction, and a second internal electrode laminated portion in which three or more second internal electrodes are laminated in the laminating direction. The second internal electrode laminated portion is opposite to the first internal electrode laminated portion in the laminating direction.

### CROSS REFERENCE TO RELATED APPLICATIONS

This application claims the benefit of priority to Japanese Patent Application No. 2016-022549 filed on Feb. 9, 2016. The entire contents of this application are hereby incorporated herein by reference.

### BACKGROUND OF THE INVENTION

### 1. Field of the Invention

The present invention relates to a multilayer ceramic capacitor.

### 2. Description of the Related Art

Conventionally, capacitors have been used in various electronic devices. For example, JP-A 2015-153764 discloses a multilayer ceramic capacitor in which internal electrodes are laminated in the laminating direction T.

Depending on the particular application, a multilayer ceramic capacitor having a large capacitance is required in some cases, or a multilayer ceramic capacitor having a small capacitance is required in some cases. As a method for adjusting the capacitance of the multilayer ceramic capacitor, a technique of reducing the number of laminations of internal electrodes is conceivable. However, reduction in the number of laminations of internal electrodes has the problem of deterioration in the strength of the multilayer ceramic capacitor.

### SUMMARY OF THE INVENTION

Preferred embodiments of the present invention provide a multilayer ceramic capacitor having high strength.

A multilayer ceramic capacitor according to a preferred embodiment of the present invention includes a capacitor body, a first external electrode, a second external electrode, a first internal electrode, and a second internal electrode. The capacitor body includes first and second principal surfaces, first and second lateral surfaces, and first and second end surfaces. The first and the second principal surfaces extend in a length direction and a width direction. The first and the second lateral surfaces extend in the length direction and a laminating direction. The first and the second end surfaces extend in the width direction and the laminating direction. The first external electrode is disposed on at least one surface of the first and the second lateral surfaces and the first and the second end surfaces. The second external electrode is disposed on at least one surface of the first and the second lateral surfaces and the first and the second end surfaces, at a position different from the position where the first external electrode is disposed. The first internal electrode is disposed inside the capacitor body, and connected with the first external electrode. The second internal electrode is disposed inside the capacitor body, and connected with the second external electrode. The capacitor body includes a first internal electrode laminated portion in which three or more first internal electrodes are laminated sequentially in the laminating direction, and a second internal electrode laminated portion in which three or more second internal electrodes are laminated sequentially in the laminating direction. The second internal electrode laminated portion is opposite to the first internal electrode laminated portion in the laminating direction.

In a multilayer ceramic capacitor according to a preferred embodiment of the present invention, the first and the second internal electrode laminated portions are provided. Therefore, it is possible to decrease the capacitance without reducing the number of laminations of the internal electrodes. Therefore, it is possible to realize a multilayer ceramic capacitor having high strength and a low capacitance.

In a multilayer ceramic capacitor according to a preferred embodiment of the present invention, a value obtained by dividing a distance between the first internal electrode laminated portions adjacent in the laminating direction by the sum of a thickness of the second internal electrode and a distance between the second internal electrodes adjacent in the laminating direction ((a distance between the first internal electrode laminated portions adjacent in the laminating direction)/{(a thickness of the second internal electrode)+(a distance between the second internal electrodes adjacent in the laminating direction)}) is preferably 25 or less. A value obtained by dividing a distance between the second internal electrode laminated portions adjacent in the laminating direction by the sum of a thickness of the first internal electrode and a distance between the first internal electrodes adjacent in the laminating direction ((a distance between the second internal electrode laminated portions adjacent in the laminating direction)/{(a thickness of the first internal electrode)+(distance between the first internal electrodes adjacent in the laminating direction)}) is preferably 25 or less. In this case, it is possible to significantly reduce or prevent the occurrence of a structural defect inside the multilayer ceramic capacitor.

In a multilayer ceramic capacitor according to a preferred embodiment of the present invention, it is preferred that each of a distance between the first internal electrode laminated portions adjacent in the laminating direction, and a distance between the second internal electrode laminated portions adjacent in the laminating direction is about 31 μm or less, for example. In this case, it is possible to significantly reduce or prevent the occurrence of a structural defect inside the multilayer ceramic capacitor.

In a multilayer ceramic capacitor according to a preferred embodiment of the present invention, it is preferred that the capacitor body includes an alternate laminated portion in which the first internal electrode and the second internal electrode are laminated alternately in the laminating direction.

The alternate laminated portion in various preferred embodiments of the present invention is a portion in which the first internal electrode laminated portion and the second internal electrode laminated portion are adjacent to each other in the laminating direction. The alternate laminated portion in various preferred embodiments of the present invention does not include the portion where the first internal electrode and the second internal electrode are laminated while they are adjacent to each other in the laminating direction.

In a multilayer ceramic capacitor according to a preferred embodiment of the present invention, it is preferred that the external electrode to which the internal electrode disposed closest to the first principal surface in the capacitor body is connected is different from the external electrode to which the internal electrode adjacent in the laminating direction is connected. In this case, a capacitance is generated between the internal electrode situated closest to the first principal surface in the capacitor body, and the internal electrode adjacent in the laminating direction. When the multilayer ceramic capacitor is mounted in such a manner that the first principal surface is the mounting surface, it is possible to decrease the equivalent series inductance (ESL) of the multilayer ceramic capacitor.

In a multilayer ceramic capacitor according to a preferred embodiment of the present invention, it is preferred that the external electrode to which the internal electrode situated closest to the second principal surface in the capacitor body is connected is different from the external electrode to which the internal electrode adjacent in the laminating direction is connected. In this case, a capacitance is generated between the internal electrode situated closest to the second principal surface in the capacitor body, and the internal electrode adjacent in the laminating direction. When the multilayer ceramic capacitor is mounted in such a manner that the second principal surface is the mounting surface, it is possible to decrease the equivalent series inductance (ESL) of the multilayer ceramic capacitor.

In a multilayer ceramic capacitor according to a preferred embodiment of the present invention, it is preferred that the capacitor body includes a portion where the first internal electrode laminated portion and the second internal electrode laminated portion are alternately laminated and include a total of eleven or more layers.

According to various preferred embodiments of the present invention, it is possible to provide a multilayer ceramic capacitor having high strength.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic perspective view of a capacitor according to a first preferred embodiment of the present invention.

FIG. 2 is a schematic cross-section view along line II-II in FIG. 1.

FIG. 3 is a schematic cross-section view of the capacitor according to the first preferred embodiment of the present invention.

FIG. 4 is a schematic cross-section view of the capacitor according to the first preferred embodiment of the present invention.

FIG. 5 is a schematic cross-section view along line V-V in FIG. 1.

FIG. 6 is a schematic cross-section view of a capacitor according to a second preferred embodiment of the present invention.

FIG. 7 is a schematic cross-section view of a capacitor according to a third preferred embodiment of the present invention.

FIG. 8 is a schematic cross-section view of a capacitor according to a fourth preferred embodiment of the present invention.

FIG. 9 is a schematic cross-section view of a capacitor according to a fifth preferred embodiment of the present invention.

FIG. 10 is a schematic cross-section view of a capacitor according to a sixth preferred embodiment of the present invention.

FIG. 11 is a schematic cross-section view of a capacitor according to a seventh preferred embodiment of the present invention.

FIG. 12 is a schematic cross-section view of the capacitor according to the seventh preferred embodiment of the present invention.

FIG. 13 is a schematic cross-section view for illustrating a method for measuring thickness of a dielectric layer and an internal electrode.

### DETAILED DESCRIPTION OF THE PREFERRED EMBODIMENTS

Hereinafter, examples of preferred embodiments of the present invention will be described. The following preferred embodiments are given merely for illustration. The present invention is not limited in any way by the following preferred embodiments.

In each drawing that is referred to in the description of preferred embodiments and the like, the member having substantially the same function is denoted by the same reference numeral. Drawings that are referred to in preferred embodiments and the like are schematically depicted. The dimensional ratio and the like of objects depicted in each drawing may be different from the actual dimensional ratio of the objects. Also between different drawings, the dimensional ratios and the like of objects can be different. Specific dimensional ratios and the like should be determined referring to the following description.

### First Preferred Embodiment

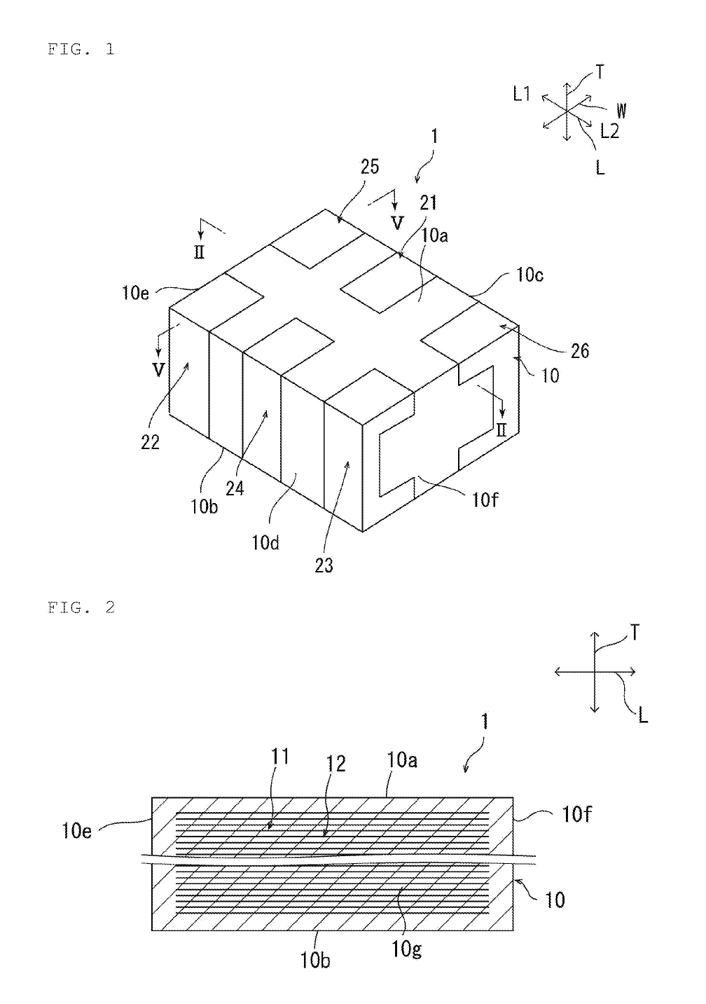

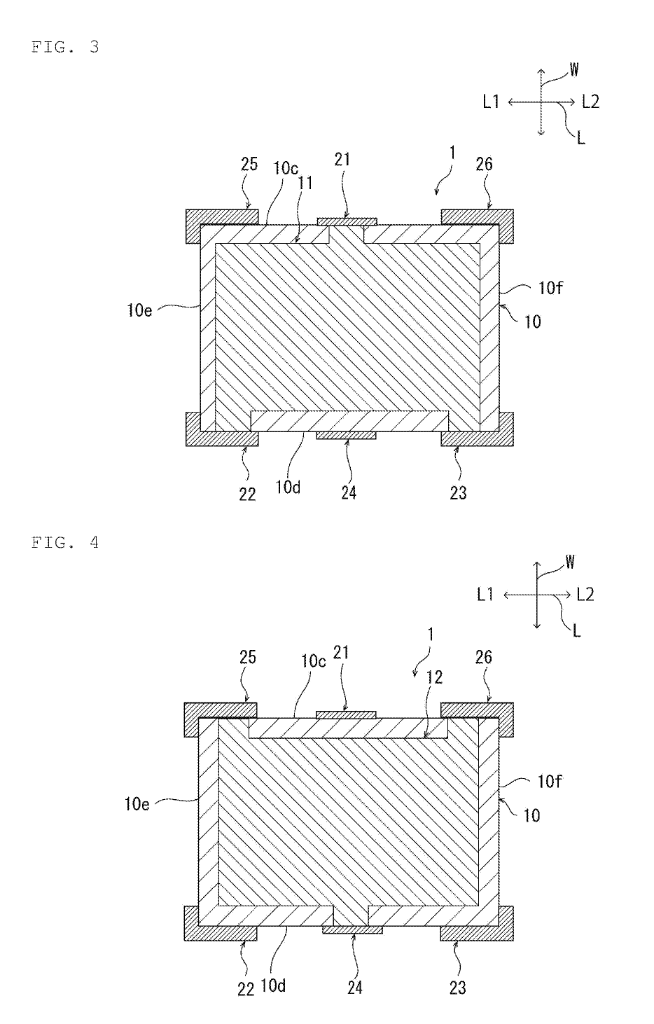

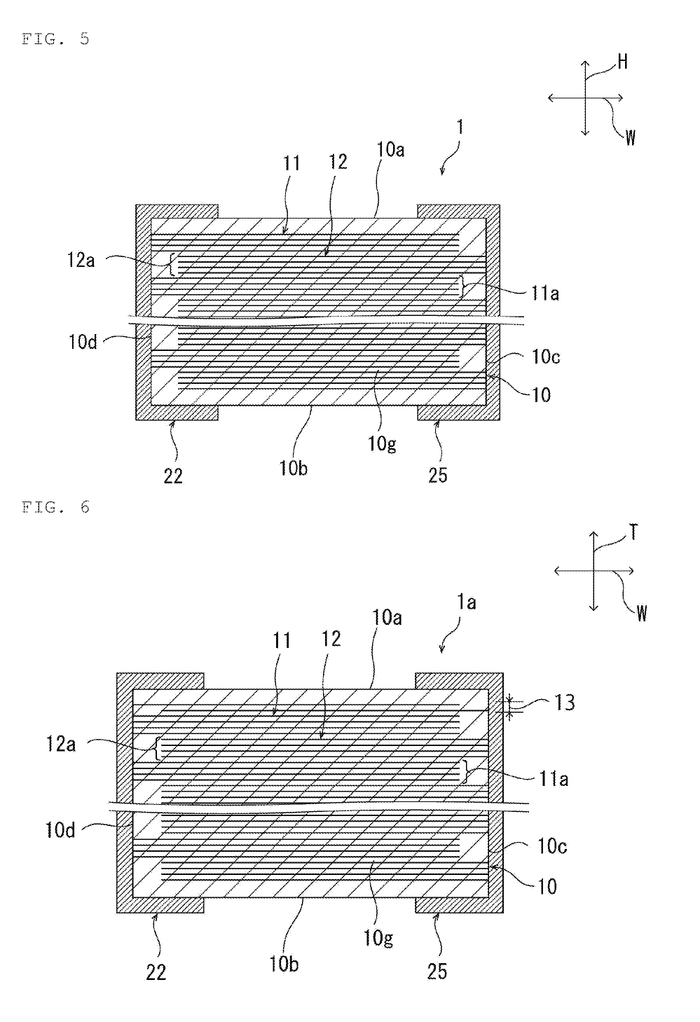

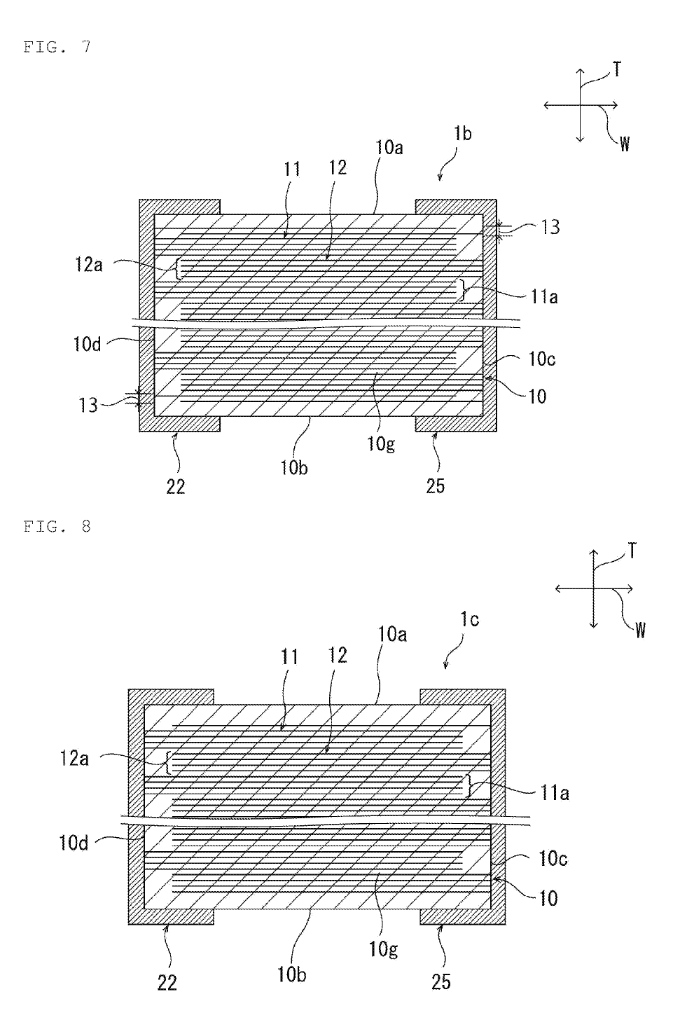

FIG. 1 is a schematic perspective view of a capacitor according to a first preferred embodiment of the present invention. FIG. 2 is a schematic cross-section view along line II-II in FIG. 1. FIG. 3 is a schematic cross-section view of the capacitor according to the first preferred embodiment. FIG. 4 is a schematic cross-section view of the capacitor according to the first preferred embodiment. FIG. 5 is a schematic cross-section view along line V-V in FIG. 1.

As shown in FIG. 1 to FIG. 5, a capacitor 1 includes a capacitor body 10. The capacitor body 10 preferably has a rectangular or substantially rectangular parallelepiped shape. The capacitor body 10 includes first and second principal surfaces 10a, 10b, first and second lateral surfaces 10c, 10d, and first and second end surfaces 10e, 10f. Each of the first and the second principal surfaces 10a, 10b extends in a length direction L and a width direction W. The width direction W is perpendicular to the length direction L. Each of the first and the second lateral surfaces 10c, 10d extends in the length direction L and a laminating direction T. The laminating direction T is perpendicular to each of the length direction L and the width direction W. Each of the first and the second end surfaces 10e, 10f extends in the width direction W and the laminating direction T. Ridges and corners of the capacitor body 10 may have chamfered shapes or rounded shapes, however, from the view point of significantly reducing or preventing the occurrence of cracking, they preferably have rounded shapes.

The capacitor body 10 can be formed, for example, of appropriate dielectric ceramics. Specifically, the capacitor body 10 may be formed of dielectric ceramics including, for example, BaTiO₃, CaTiO₃, SrTiO₃, and CaZrO₃. The capacitor body 10 may be added with Mn compounds, Fe compounds, Cr compounds, Co compounds, and Ni compounds.

Letting the height dimension of the capacitor body 10 be DT, the length dimension be DL, and the width dimension be DW, the dimension of the capacitor body 10 preferably satisfies, but is not limited to, DT<DW<DL, for example. Preferably, DT<0.7 mm is satisfied, and more preferably, 0.05 mm≦DT<0.5 mm is satisfied, for example. Also, 0.4 mm≦DL≦1.2 mm is preferred, for example. Also, 0.3 mm≦DW≦0.7 mm is preferred, for example.

As shown in FIG. 1, FIG. 3 and FIG. 4, the capacitor 1 includes first external electrodes 21, 22, 23, and second external electrodes 24, 25, 26. Each of the first external electrodes 21, 22, 23, and the second external electrodes 24, 25, 26 is disposed on at least one surface of the first and the second lateral surfaces 10c, 10d, and the first end surfaces 10e, 10f of the capacitor body 10.

As shown in FIG. 3, in the present preferred embodiment, the first external electrode 21 is disposed on a middle portion in the length direction L of the first lateral surface 10c. As shown in FIG. 1, the first external electrode 21 is disposed on each of the first and the second principal surfaces 10a, 10b so as to straddle these principal surfaces from above the first lateral surface 10c. As shown in FIG. 3, the exposed portion of a first extended portion of a first internal electrode 11 is covered with the first external electrode 21.

The first external electrode 23 is disposed on a portion on an L2 side in the length direction L of the second lateral surface 10d. As shown in FIG. 1, FIG. 3 and FIG. 4, the first external electrode 23 is disposed on each of the first and the second principal surfaces 10a, 10b, and the second end surface 10f so as to straddle these surfaces from above the second lateral surface 10d. As shown in FIG. 3, the exposed portion of the third extended portion of the first internal electrode 11 is covered with the first external electrode 23. As shown in FIG. 1, in the present preferred embodiment, the portion of the first external electrode 23 situated on the second end surface 10f preferably is U-shaped or substantially U-shaped, however, the shape is not limited to this. The portion of the first external electrode 23 situated on the second end surface 10f may be, for example, a rectangular or substantially rectangular. Although the first external electrode 23 may not be disposed on the second end surface 10f, it is preferably disposed.

The first external electrode 22 is disposed on a portion on an L1 side in the length direction L of the second lateral surface 10d. As shown in FIG. 1, FIG. 3, FIG. 4 and FIG. 5, the first external electrode 22 is disposed on each of the first and the second principal surfaces 10a, 10b, and the first end surface 10e so as to straddle these surfaces from above the second lateral surface 10d. As shown in FIG. 3, the exposed portion of a second extended portion of the first internal electrode 11 is covered with the first external electrode 22. In the present preferred embodiment, the portion of the first external electrode 22 situated on the first end surface 10e preferably is U-shaped or substantially U-shaped like the first external electrode 23, however, the shape is not limited to this. The portion of the first external electrode 22 situated on the first end surface 10e may be, for example, rectangular or substantially rectangular. Although the first external electrode may not be disposed on the first end surface 10e, it is preferably disposed.

As shown in FIG. 4, the second external electrode 24 is disposed on a middle portion in the length direction L of the second lateral surface 10d. As shown in FIG. 1, the second external electrode 24 is disposed on each of the first and the second principal surfaces 10a, 10b so as to straddle these principal surfaces from above the second lateral surface 10d. As shown in FIG. 4, the exposed portion of a first extended portion of the second internal electrode 12 is covered with the second external electrode 24.

The second external electrode 25 is disposed on a portion on an L1 side in the length direction L of the first lateral surface 10c. As shown in FIG. 1, FIG. 3, FIG. 4 and FIG. 5, the second external electrode 25 is disposed on each of the first and the second principal surfaces 10a, 10b, and the first end surface 10e so as to straddle these surfaces from above the first lateral surface 10c. As shown in FIG. 4, the exposed portion of a second extended portion of the second internal electrode 12 is covered with the second external electrode 25. In the present preferred embodiment, the portion of the second external electrode 25 situated on the first end surface 10e preferably is U-shaped or substantially U-shaped like the first external electrode 23, however, the shape is not limited to this. The portion of the second external electrode 25 situated on the first end surface 10e may be, for example, rectangular or substantially rectangular. Although the second external electrode 25 may not be disposed on the first end surface 10e, it is preferably disposed.

The second external electrode 26 is disposed on a portion on an L2 side in the length direction L of the first lateral surface 10c. As shown in FIG. 1, FIG. 3 and FIG. 4, the second external electrode 26 is disposed on each of the first and the second principal surfaces 10a, 10b, and the second end surface 10f so as to straddle these surfaces from above the first lateral surface 10c. As shown in FIG. 4, the exposed portion of the third extended portion of the second internal electrode 12 is covered with the second external electrode 26. As shown in FIG. 1, in the present preferred embodiment, the portion of the second external electrode 26 situated on the second end surface 10f preferably is U-shaped or substantially U-shaped like the first external electrode 23, however, the shape is not limited to this. The portion of the second external electrode 26 situated on the second end surface 10f may be, for example, rectangular or substantially rectangular shape.

Although the second external electrode 26 may not be disposed on the second end surface 10f, it is preferably disposed.

Each of the first and the second external electrodes 21 to 26 can include an appropriate conductive material. Each of the first and the second external electrodes 21 to 26 can be defined, for example, of a laminate of a base electrode layer disposed on the capacitor body 10, a Ni plating layer disposed on the base electrode layer, and a Sn plating layer disposed on the Ni plating layer.

The base electrode layer can include, for example, a fired electrode layer, a plating layer, and a conductive resin layer. The fired electrode layer is an electrode that is formed by baking an applied conductive paste. Preferably, the base electrode layer includes at least one metal selected from the group consisting of, for example, Cu, Ni, Ag, Pd, Ag—Pd alloy, and Au. The base electrode layer preferably contains glass. The glass contained in the base electrode layer preferably contains Si, Zn.

The Ni plating layer is disposed on the base electrode layer. By providing the Ni plating layer, it is possible to effectively reduce or prevent the erosion of the base electrode layer by a solder when the capacitor 1 is mounted on the mounting board, for example, by using the solder.

In the present preferred embodiment, description has been made for the example where each of the external electrodes 21 to 26 extends onto the first and the second principal surfaces 10a, 10b. However, the present invention is not limited to this configuration. For example, the external electrodes may be provided only on the lateral surfaces or the end surfaces. Also, four or more external electrodes may be disposed on one lateral surface, for example.

From the view point of significantly reducing or preventing the occurrence of cracking or chipping in the capacitor body 10, it is preferred that at least a portion of the ridges of the capacitor body 10 is covered with the external electrodes 21 to 26.

As shown in FIG. 2 to FIG. 5, inside the capacitor body 10, the first internal electrode 11 and the second internal electrode 12 are disposed. The first internal electrode 11 is connected with each of the first external electrodes 21 to 23. The second internal electrode 12 is connected with each of the second external electrodes 24 to 26.

The first and the second internal electrodes 11, 12 can include an appropriate conductive material. The first and the second internal electrodes can be made, for example, of metal such as Ni, Cu, Ag, Pd, and Au, or alloys containing one of these metals, such as an Ag—Pd alloy. More preferably, the first and the second internal electrodes 11, 12 contain Ni. The first and the second internal electrodes 11, 12 may contain dielectric grains (common material) having a composition system similar to that of the ceramics contained in the capacitor body 10.

For the purpose of generating a capacitance, it is necessary to make the first internal electrode and the second internal electrode be opposite to each other with a dielectric layer interposed therebetween. For this reason, normally, in the multilayer ceramic capacitor, the first internal electrode and the second internal electrode are disposed alternately in the laminating direction. The electrostatic capacitance of the multilayer ceramic capacitor is able to be adjusted by adjusting the number of laminations of the first and the second internal electrodes. To be more specific, to obtain a multilayer ceramic capacitor having a large electrostatic capacitance, it is necessary to increase the number of laminations of the first and the second internal electrodes. Contrarily, to obtain a multilayer ceramic capacitor having a small electrostatic capacitance, it is necessary to decrease the number of laminations of the first and the second internal electrodes. However, when the number of laminations of the first and the second internal electrodes is decreased so as to reduce the electrostatic capacitance of the multilayer ceramic capacitor, the thickness of the capacitor body is reduced. This leads the problem of deterioration in the strength of the multilayer ceramic capacitor.

In this context, as shown in FIG. 5, in the multilayer ceramic capacitor 1, the capacitor body 10 includes a first internal electrode laminated portion 11a in which three or more first internal electrodes 11 are sequentially laminated in the laminating direction T, and a second internal electrode laminated portion 12a in which three or more second internal electrodes 12 are sequentially laminated in the laminating direction T. By disposing the first internal electrode laminated portion 11a and the second internal electrode laminated portion 12a so that they are opposite to each other in the laminating direction T with a dielectric layer interposed therebetween, a capacitance is generated.

In the multilayer ceramic capacitor 1, the first internal electrodes 11 that are situated on both sides in the laminating direction T in the first internal electrode laminated portion 11a do not substantially contribute to generation of a capacitance. Similarly, the second internal electrodes 12 that are situated on both sides in the laminating direction T in the second internal electrode laminated portion 12a do not substantially contribute to generation of a capacitance. Therefore, by disposing the first internal electrode laminated portion 11a in which three or more first internal electrodes 11 are sequentially laminated in the laminating direction, and the second internal electrode laminated portion 12a in which three or more second internal electrodes 12 are sequentially laminated in the laminating direction, it is possible to realize the multilayer ceramic capacitor 1 having a small electrostatic capacitance without reducing the number of laminations of the internal electrodes 11, 12. In other words, by disposing the first and the second internal electrode laminated portions 11a, 12a, it is possible to realize the multilayer ceramic capacitor 1 having high strength and a low electrostatic capacitance.

From the view point of further increasing the strength of the multilayer ceramic capacitor 1 while acquiring the low capacitance, preferably five or more, more preferably seven or more internal electrodes 11, 12 are laminated in each of the internal electrode laminated portions 11a, 12a, for example.

From the similar point of view, it is preferred that the capacitor body 10 includes a portion where the first internal electrode laminated portions 11a and second internal electrode laminated portions 12a are alternately laminated and include a total of eleven or more layers, for example.

However, when the number of laminations of the internal electrodes in each internal electrode laminated portion is too large, or when the number of laminations of the internal electrodes 11, 12 in the internal electrode laminated portions 11, 12 is too large, the distance between the first internal electrode laminated portions 11a adjacent in the laminating direction T, and the distance between the second internal electrode laminated portions 12a adjacent in the laminating direction T increase. At this time, for example, in FIG. 5, a large difference in the thermal expansion rate arises when the ambient temperature changes, or at the time of firing, or baking, between the portion of the dielectric layer surrounded by the first external electrode 22, the second internal electrode laminated portion 12a and the first internal electrode laminated portion 11a adjacent to the first external electrode 22 in the laminating direction where the internal electrodes 11, 12 are not disposed, and the portion of the dielectric layer where the internal electrodes 11, 12 are disposed. Therefore, a stress is exerted on the portion of the dielectric layer where the internal electrodes 11, 12 are not disposed, and an internal defect can occur in the capacitor body 10. Occurrence of an internal defect in the capacitor body 10 can deteriorate the reliability of the multilayer ceramic capacitor 1. Therefore, from the view point of significantly reducing or preventing deterioration of the reliability of the multilayer ceramic capacitor 1, the value obtained by dividing the distance between the first internal electrode laminated portions 11a adjacent in the laminating direction T by the sum of the thickness of the second internal electrode 12 and the distance between the second internal electrodes 12 adjacent in the laminating direction T ((distance between the first internal electrode laminated portions 11a adjacent in the laminating direction T)/{(thickness of the second internal electrode 12)+(distance between the second internal electrodes 12 adjacent in the laminating direction T)}) is preferably 25 or less, more preferably 8 or less, for example. The value obtained by dividing the distance between the second internal electrode laminated portions 12a adjacent in the laminating direction T by the sum of the thickness of the first internal electrode 11 and the distance between the first internal electrodes 11 adjacent in the laminating direction T ((distance between the second internal electrode laminated portions 12a adjacent in the laminating direction T)/{(thickness of the first internal electrode 11)+(distance between the first internal electrodes 11 adjacent in the laminating direction T)}) is preferably 25 or less, more preferably 8 or less, for example.

To be more specific, each of the distance between the first internal electrode laminated portions 11a adjacent in the laminating direction, and the distance between the second internal electrode laminated portions 12a adjacent in the laminating direction is preferably about 31 μm or less, more preferably about 26 μm or less, and further preferably about 18 μm or less, for example.

From the view point of obtaining the multilayer ceramic capacitor 1 having high strength and excellent reliability, the average thickness of the internal electrodes 11, 12 preferably is about 0.4 μm or more and about 1.0 μm or less, for example. The thickness of a dielectric layer 10g situated between the internal electrodes adjacent in the laminating direction T is preferably about 0.5 μm or more and about 3 μm or less, for example.

Preferably, the internal electrodes 11, 12 are connected with the external electrodes 21, 24 other than the external electrodes 22, 23, 25, 26 situated on either end in the length direction L of the lateral surface 10c, 10d of the capacitor body 10. This makes it possible to increase the connecting reliability between the internal electrodes and the external electrodes.

From the view point of significantly reducing or preventing entry of the water or the like into the capacitor body 10, preferably, the internal electrodes 11, 12 are not exposed on the end surfaces 10e, 10f of the capacitor body 10.

Next, one non-limiting example of a production method of a multilayer ceramic capacitor 1 will be described.

First, a ceramic green sheet, a conductive paste for an internal electrode, and a conductive paste for an external terminal electrode are prepared. The ceramic green sheet and the conductive pastes may contain a binder and a solvent. The binder and the solvent used in the ceramic green sheet and the conductive pastes can be those known in the art.

Next, on the ceramic green sheet, the conductive paste is printed in a predetermined pattern, for example, by the screen printing or the gravure printing, to form an internal electrode pattern.

Next, a predetermined number of ceramic green sheets for an outer layer on which an internal electrode pattern is not printed are laminated, and ceramic green sheets on which an internal electrode pattern is printed are sequentially laminated thereon, and a predetermined number of ceramic green sheets for an outer layer are laminated thereon, and thus a mother laminate is prepared. Then the mother laminate is pressed in the laminating direction by isostatic pressing or the like.

Next, the mother laminate is cut into a predetermined size and a raw ceramic laminate is cut out. At this time, ridges and corners of the raw ceramic laminate may be rounded by barrel finishing or the like.

On an internal electrode exposed portion that is exposed on the lateral surface of the raw ceramic laminate that is cut into a predetermined size, an electrode paste for forming the base electrode layers is applied. The method for applying the electrode paste is not limited. The method for applying the electrode paste can be, for example, a roller transfer method.

Next, by firing the raw ceramic laminate, the capacitor body 10 is obtained. The sintering temperature is preferably about 900° C. or more and about 1300° C. or less, for example, depending on the ceramic material and conductive material. Thereafter, ridges and corners of the capacitor body 10 may be rounded by subjecting the capacitor body 10 to barrel finishing or the like.

In the multilayer ceramic capacitor 1 according to the present preferred embodiment, the first and the second internal electrode laminated portions 11a, 12a are provided. Therefore, it is possible to realize a low capacitance without reducing the number of laminations of the internal electrodes 11, 12. When the number of laminations of the internal electrodes 11, 12 is reduced, the proportion of volume of the internal electrodes 11, 12 in the capacitor body 10 is reduced. In this case, the contraction behavior at the time of firing of the raw ceramic laminate largely changes as compared with before reducing the number of laminations of the internal electrodes 11, 12. Therefore, when firing is conducted in the same conditions as those before reducing the number of laminations of the internal electrodes 11, 12, a defect such as cracking can occur at the time of firing. In particular, when the number of laminations of the internal electrodes 11, 12 is reduced for the purpose of acquiring a lower capacitance, the difference in contraction behavior at the time of firing between the portion where the volume proportion of the internal electrodes 11, 12 in the capacitor body 10 is large, and the portion where the volume proportion of internal electrodes 11, 12 in the capacitor body 10 is small is further increased, and the defect is extended. Therefore, even when the multilayer ceramic capacitor 1 according to the present preferred embodiment has a low capacitance, the capacitor 1 is able to be produced efficiently.

Next, the Ni plating layers 21b to 26b are formed, and then the Sn plating layers 21c to 26c are formed, and thus the multilayer ceramic capacitor 1 can be completed. Hereinafter, other examples of preferred embodiments of the present invention will be described. In the following description, the member, element or feature having a function that is the same or substantially the same as that in the first preferred embodiment is denoted by the common reference numeral, and the description thereof is omitted.

### Second to Fifth Preferred Embodiments

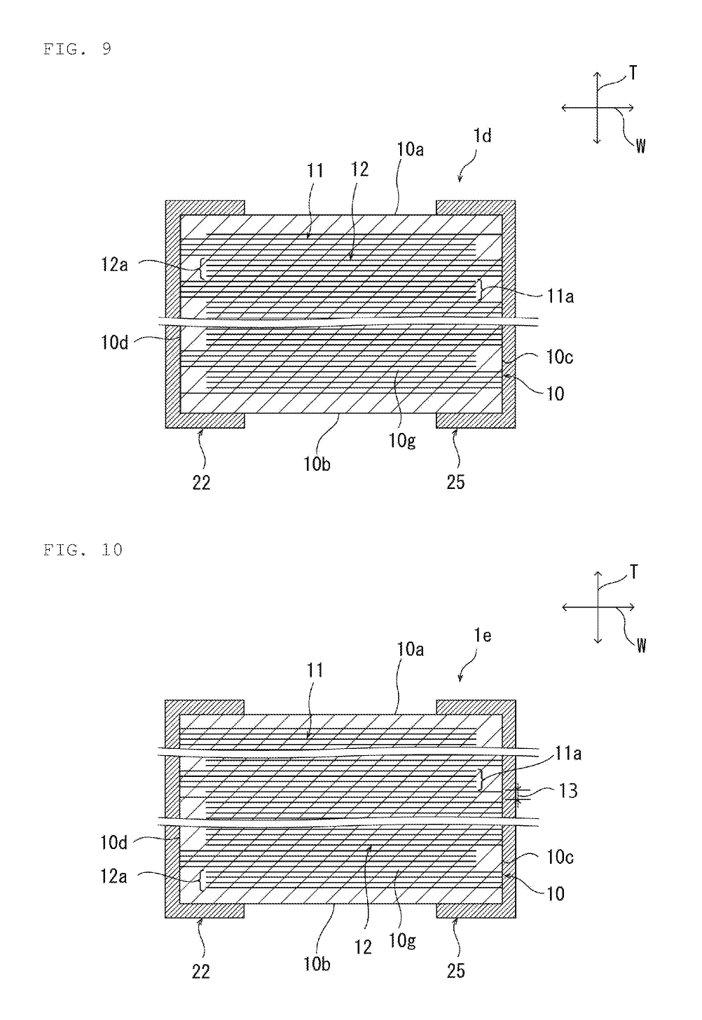

FIG. 6 is a schematic cross-section view of a capacitor 1a according to a second preferred embodiment of the present invention. FIG. 7 is a schematic cross-section view of a capacitor 1b according to a third preferred embodiment of the present invention. FIG. 8 is a schematic cross-section view of a capacitor 1c according to a fourth preferred embodiment of the present invention. FIG. 9 is a schematic cross-section view of a capacitor 1d according to a fifth preferred embodiment of the present invention. FIG. 10 is a schematic cross-section view of a capacitor 1e according to a sixth preferred embodiment of the present invention.

In the capacitor 1 according to the first preferred embodiment, description was made for the example where all of the first internal electrodes 11 define the first internal electrode laminated portion 11a, and all of the second internal electrodes 12 define the second internal electrode laminated portion 12a. However, the present invention is not limited to this configuration. Likewise the multilayer ceramic capacitors 1a, 1b shown in FIG. 6 and FIG. 7, the capacitor body 10 may include an alternate laminated portion 13 in which the first internal electrode 11 and the second internal electrode 12 are alternately laminated in the laminating direction T. To be more specific, in the multilayer ceramic capacitor 1a shown in FIG. 6, the alternate laminated portion 13 is disposed in a portion closest to the first principal surface 10a in the region where the first and the second internal electrodes 11, 12 are disposed in the laminating direction T. In the multilayer ceramic capacitor 1b shown in FIG. 7, the alternate laminated portion 13 is disposed both in a portion situated closest to the first principal surface 10a and in a portion situated closest to the second principal surface 10b in the region where the first and the second internal electrodes 11, 12 are disposed in the laminating direction T. In this manner, by disposing the alternate laminated portion 13 in portions situated closest to the principal surface 10a, 10b in the region where the first and the second internal electrodes 11, 12 are disposed in the laminating direction T, it is possible to shorten the length of the path through which the current flows in the multilayer ceramic capacitors 1a, 1b regardless of any one of the principal surfaces 10a, 10b is a mounting surface in mounting the multilayer ceramic capacitors 1a, 1b. Therefore, it is possible to decrease the equivalent series inductance (ESL) of the multilayer ceramic capacitors 1a, 1b.

Similarly, also when the internal electrode 12 is disposed closest to the principal surface 10a in the capacitor body 10 so as to generate a capacitance with the internal electrode 11 adjacent in the laminating direction T as in the multilayer ceramic capacitor 1c shown in FIG. 8, or when the internal electrodes 12, 11 are disposed closest to the principal surface 10a, 10b in the capacitor body 10 so as to generate a capacitance with the internal electrodes 11, 12 adjacent in the laminating direction T as in the multilayer ceramic capacitor 1d shown in FIG. 9, it is possible to shorten the length of the path through which the current flows in the multilayer ceramic capacitors 1c, 1d. Therefore, it is possible to decrease the ESL of the multilayer ceramic capacitors 1c, 1d.

In the multilayer ceramic capacitor 1c shown in FIG. 8, it is sometimes the case that two or more internal electrodes 12 disposed closest to the principal surface 10a in the capacitor body 10 are sequentially laminated in the laminating direction T. In this manner, by protecting the internal electrode 12 disposed on the inner side of the capacitor body 10 of the two sequentially laminated internal electrodes 12 by the internal electrode 12 disposed on the outer side of the capacitor body 10, it is possible to improve the reliability such as moisture resistance.

Similarly, in the multilayer ceramic capacitor 1d shown in FIG. 9, it is sometimes the case that two or more internal electrodes 12 disposed closest to the principal surface 10a in the capacitor body 10 are sequentially laminated in the laminating direction T, and two or more internal electrodes 11 disposed closest to the principal surface 10b in the capacitor body 10 are sequentially laminated in the laminating direction T.

As in the multilayer ceramic capacitor 1e shown in the FIG. 10, the alternate laminated portion 13 may be disposed between the first internal electrode laminated portion 11a and the second internal electrode laminated portion 12a.

### Seventh Preferred Embodiment

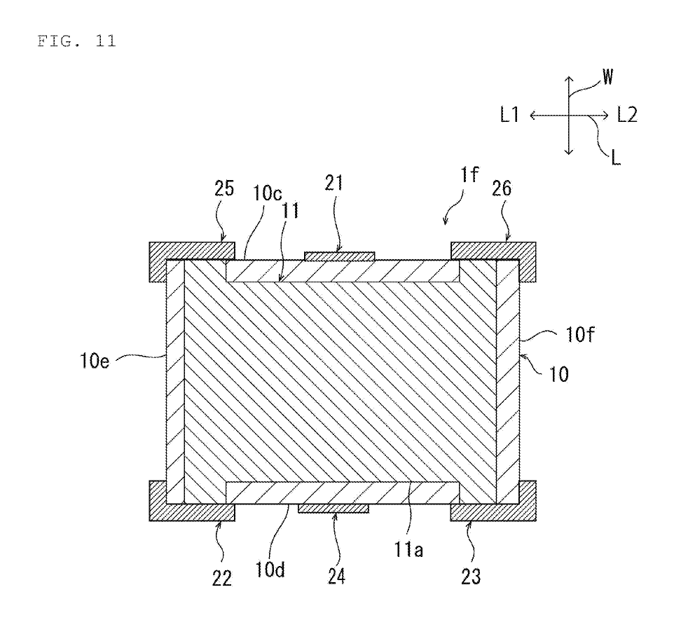

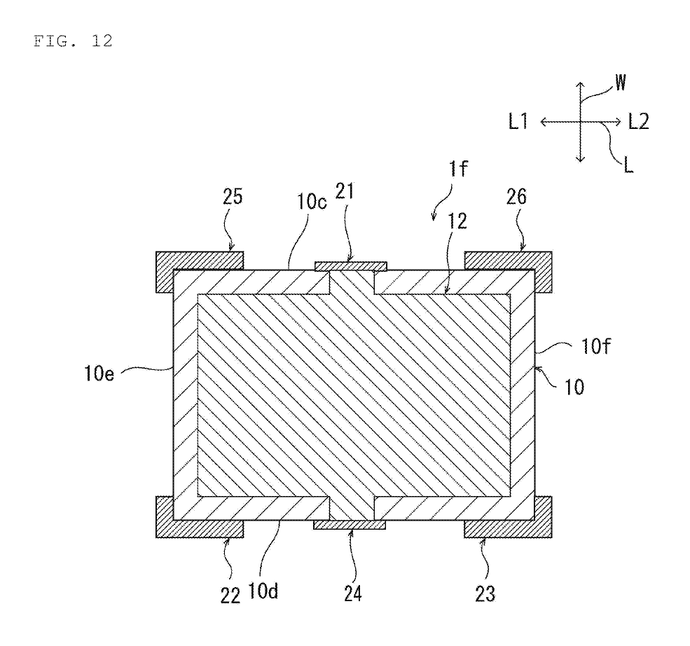

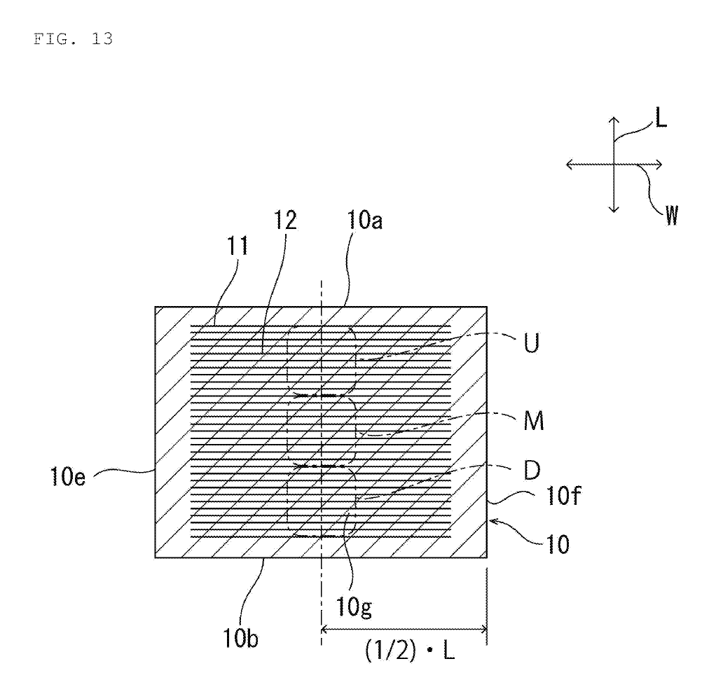

FIG. 11 is a schematic cross-section view of a capacitor according to a seventh preferred embodiment of the present invention. FIG. 12 is a schematic cross-section view of the capacitor according to the seventh preferred embodiment of the present invention.

The multilayer ceramic capacitor 1f according to the present preferred embodiment is different from the multilayer ceramic capacitor 1 according to the first preferred embodiment in the connection between the internal electrodes 11, 12 and the external electrodes 21 to 26. In the present invention, the connection between the internal electrodes and the external electrodes is not particularly limited. In the multilayer ceramic capacitor if according to the present preferred embodiment, the first internal electrode 11 is connected with the external electrodes 22, 23, 25, 26, and the second internal electrode 12 is connected with the external electrodes 21, 24.

From the view point of decreasing the ESL, it is preferred to connect the internal electrodes 11, 12 and the external electrodes 21 to 26 in the manner of the first preferred embodiment. In this case, since the external electrodes that are adjacent to each other in the length direction L and the external electrodes that are opposite to each other in the width direction W have mutually different polarities, the generated magnetic fields are mutually cancelled. Hereinafter, additional various preferred embodiments of the present invention will be described based on specific examples, however, it is to be noted that the present invention will not be limited in any way by the following examples, and can be practiced with an appropriate modification without departing from the scope of the invention.

### EXAMPLE 1

A capacitor having substantially the same configuration as that of the multilayer ceramic capacitor 1 according to the first preferred embodiment was prepared under the following conditions.

Main ingredients of the capacitor body: barium titanate to which Mg, V, Dy, and Si are added.

Thickness of the dielectric layer: 0.7 μm on average

Thickness of the internal electrode: 0.52 μm on average

### Method for Measuring the Thicknesses of the Dielectric Layer and the Internal Electrode

First, three samples were prepared, and each sample was put in a vertically standing position, and the circumference of each sample was solidified with a resin.

At this time, lateral surfaces in the length direction L and the laminating direction T of each sample were exposed. The lateral surfaces were polished with a polisher, and the polishing was ended at a depth of ½ in the W direction of the capacitor body, and thus the polished surface was exposed. This polishing surface was subjected to ion milling to remove sags generated by the polishing. In this manner, a section for observation was obtained.

As shown in FIG. 13, at a position of ½ in the L direction of the section in the length direction L and the laminating direction T, a perpendicular line orthogonal to internal electrodes was drawn. Next, the region of the sample where internal electrodes are laminated was divided into three equal portions in the laminating direction, and divided into three regions: an upper portion U, a middle portion M and a lower portion D. Then ten dielectric layers were chosen from a respective center portion in the laminating direction of each region, and the thickness of these dielectric layers on the perpendicular line was measured. However, the one that was unmeasurable due to a defect of an internal electrode on the perpendicular line accompanied by connection between the ceramics layers sandwiching the internal electrode was excluded.

In the manner as described above, the thickness of the dielectric layer was measured at 30 points for each sample, and an average value of these measurements was determined. Therefore, an average value of thickness of the dielectric layer at a total of 90 points (the number of samples×the number of regions×the number of lamination: 3×3×10) was obtained.

In the same manner as described above, for each sample, the thickness of the internal electrode was measured at 30 points, and an average value of these measurements was determined. In Example 1, the thickness of the first internal electrode and the thickness of the second internal electrode are substantially identical. Therefore, an average value of the thickness of the internal electrode at 90 points (the number of samples×the number of regions×the number of lamination: 3×3×10) was obtained. However, an unmeasurable portion due to a defect in the internal electrode or the like was excluded from the objects to be measured.

The thickness of the dielectric layer and the thickness of the internal electrode were measured by using a scanning electron microscope.

Distance between the internal electrode situated closest to the principal surface and the principal surface: 30 μm on average

Thickness of the first to the sixth external electrodes (the thickest portion in the W direction): 20 μm on average

Thickness of the Ni plating layer of the first to the sixth external electrodes: 4 μm

Thickness of the Sn plating layer of the first to the sixth external electrodes: 4 μm

Length dimension of the capacitor body: 1.14 mm

Width dimension of the capacitor body: 0.57 mm

Height dimension of the capacitor body: 0.4 mm

Distance between the portion where the first internal electrode and the second internal electrode are opposite to each other, and the end surface: 50 μm on average

Distance between the portion where the first internal electrode and the second internal electrode are opposite to each other, and the lateral surface: 50 μm on average

Firing temperature: 1200° C.

Baking temperature: 920° C.

Number of laminations of internal electrodes in each internal electrode laminated portion: 3 layers

Number of laminations of internal electrode laminated portions: 90 layers

Distance between first internal electrode laminated portions adjacent in the laminating direction T: 5 μm

Distance between second internal electrode laminated portions adjacent in the laminating direction T: 5 μm

The distance between first internal electrode laminated portions adjacent in the laminating direction T, and the distance between the second internal electrode laminated portions adjacent in the laminating direction T were measured in the following manner.

First, a prepared multilayer ceramic capacitor was solidified with a resin so that the first lateral surface was exposed, and the first lateral surface was polished parallel with the first lateral surface until the width dimension in the W direction of the capacitor body was ½. The exposed polished surface was subjected to ion milling, to remove sags generated by the polishing. Then around the center in the laminating direction T in the section in each region obtained by dividing the region where the internal electrodes are laminated into three equal portions in the laminating direction T, the distance between the first internal electrode laminated portions adjacent in the laminating direction T, and the distance between the second internal electrode laminated portions adjacent in the laminating direction T were measured. In the case of measuring the distance between the first internal electrode laminated portions, the measurement was conducted in the portion where the tip end of the internal electrode that projects most among the plurality of the second internal electrodes 12 in the length direction L is situated. In the case of measuring the distance between the second internal electrode laminated portions, the measurement was conducted in the portion where the tip end of the internal electrode that projects most among the plurality of the first internal electrodes 11 in the length direction L is situated. The measurement was conducted for four samples, and by averaging the measured distances of the twelve points, the distance between the first internal electrode laminated portions adjacent in the laminating direction T, and the distance between the second internal electrode laminated portions adjacent in the laminating direction T were respectively measured.

### EXAMPLE 2

A multilayer ceramic capacitor was prepared in the same manner as in Example 1 except that the following conditions were used.

Number of laminations of internal electrodes in each internal electrode laminated portion: 6 layers

Number of laminations of internal electrode laminated portions: 45 layers

Distance between first internal electrode laminated portions adjacent in the laminating direction T: 8 μm

Distance between second internal electrode laminated portions adjacent in the laminating direction T: 8 μm

### EXAMPLE 3

A multilayer ceramic capacitor was prepared in the same manner as in Example 1 except that the following conditions were used.

Number of laminations of internal electrodes in each internal electrode laminated portion: 12 layers

Number of laminations of internal electrode laminated portions: 22 layers

Distance between first internal electrode laminated portions adjacent in the laminating direction T: 16 μm

Distance between second internal electrode laminated portions adjacent in the laminating direction T: 16 μm

### EXAMPLE 4

A multilayer ceramic capacitor was prepared in the same manner as in Example 1 except that the following conditions were used.

Number of laminations of internal electrodes in each internal electrode laminated portion: 14 layers

Number of laminations of internal electrode laminated portions: 20 layers

Distance between first internal electrode laminated portions adjacent in the laminating direction T: 18 μm

Distance between second internal electrode laminated portions adjacent in the laminating direction T: 18 μm

### EXAMPLE 5

A multilayer ceramic capacitor was prepared in the same manner as in Example 1 except that the following conditions were used.

Number of laminations of internal electrodes in each internal electrode laminated portion: 20 layers

Number of laminations of internal electrode laminated portions: 14 layers

Distance between first internal electrode laminated portions adjacent in the laminating direction T: 26 μm

Distance between second internal electrode laminated portions adjacent in the laminating direction T: 26 μm

### EXAMPLE 6

A multilayer ceramic capacitor was prepared in the same manner as in Example 1 except that the following conditions were used.

Number of laminations of internal electrodes in each internal electrode laminated portion: 24 layers

Number of laminations of internal electrode laminated portions: 11 layers

Distance between first internal electrode laminated portions adjacent in the laminating direction T: 31 μm

Distance between second internal electrode laminated portions adjacent in the laminating direction T: 31 μm

### COMPARATIVE EXAMPLE 1

A multilayer ceramic capacitor was prepared in the same manner as in Example 1 except that the following conditions were used.

Number of laminations of internal electrodes in each internal electrode laminated portion: 30 layers

Number of laminations of internal electrode laminated portions: 9 layers

Distance between first internal electrode laminated portions adjacent in the laminating direction T: 39 μm

Distance between second internal electrode laminated portions adjacent in the laminating direction T: 39 μm

### COMPARATIVE EXAMPLE 2

A multilayer ceramic capacitor was prepared in the same manner as in Example 1 except that the following conditions were used.

Number of laminations of internal electrodes in each internal electrode laminated portion: 40 layers

Number of laminations of internal electrode laminated portions: 7 layers

Distance between first internal electrode laminated portions adjacent in the laminating direction T: 51 μm

Distance between second internal electrode laminated portions adjacent in the laminating direction T: 51 μm

In Comparative example 2, for four samples, every distance between first internal electrode laminated portions adjacent in the laminating direction T was measured, and an average value of these measurements was determined. Also, for four samples, every distance between second internal electrode laminated portions adjacent in the laminating direction T was measured, and an average value of these measurements was determined.

### COMPARATIVE EXAMPLE 3

A multilayer ceramic capacitor was prepared in the same manner as in Example 1 except that the following conditions were used.

Number of laminations of internal electrodes in each internal electrode laminated portion: 78 layers

Number of laminations of internal electrode laminated portions: 4 layers

Distance between first internal electrode laminated portions adjacent in the laminating direction T: 99 μm

Distance between second internal electrode laminated portions adjacent in the laminating direction T: 99 μm

In Comparative example 3, for ten samples, every distance between first internal electrode laminated portions adjacent in the laminating direction T was measured, and an average value of these measurements was determined. Also, for ten samples, every distance between second internal electrode laminated portions adjacent in the laminating direction T was measured, and an average value of these measurements was determined.

### Checking of Occurrence of Cracking or Chipping

For 100 samples prepared in each of Examples and Comparative examples, occurrence of cracking or chipping was checked in the following manner. The results are shown in Table 1.

### Method for Checking Cracking or Chipping

First, each sample was put in a vertically standing position, and the circumference of each sample was solidified with a resin.

At this time, end surfaces of each sample were exposed. The end surfaces were polished with a polisher, and the polishing was ended at a depth of ½ in the length direction L of the capacitor body, and thus the section in the width direction W and the laminating direction T was exposed. In this section, the dielectric layer of the portion surrounded by the first external electrode, the second internal electrode laminated portion, and the first internal electrode laminated portion adjacent in the laminating direction, and the dielectric layer of the portion surrounded by the second external electrode, the first internal electrode laminated portion, and the second internal electrode laminated portion adjacent in the laminating direction were observed. The sample in which cracking or chipping was observed in the dielectric layer was counted as a sample with occurrence of cracking or chipping. The observation was conducted by using an optical microscope.

### Measurement of ESL

Five samples prepared in each of Examples and Comparative examples were mounted on a mounting board, and ESL was measured by using a network analyzer (E5071B available from Agilent Technologies), and an average value was calculated. The measurement frequency band was 0.5 GHz or more and 8.5 GHz or less. The result is shown in Table 1.

The characters A, B, and C in Table 1 indicate the followings.

A: Number of laminations of internal electrodes in each internal electrode laminated portion

B: Number of laminations of internal electrode laminated portions

C: Distance between first internal electrode laminated portions adjacent in the laminating direction T (=Distance between second internal electrode laminated portions adjacent in the laminating direction T)

TABLE 1

| | | | | Number of | |
|---|---|---|---|---|---|
| | | | | occurrence of | |
| | | | C | cracking or | ESL |
| | A | B | (μm) | chipping | (pH) |
| Example 1 | 3 | 90 | 5 | 0 | 36 |
| Example 2 | 6 | 45 | 8 | 0 | 37 |
| Example 3 | 12 | 22 | 16 | 0 | 40 |
| Example 4 | 14 | 20 | 18 | 0 | 43 |
| Example 5 | 20 | 14 | 26 | 0 | 46 |
| Example 6 | 24 | 11 | 31 | 2 | 47 |
| Comparative | 30 | 9 | 39 | 10 | 48 |
| Example 1 | | | | | |
| Comparative | 40 | 7 | 51 | 11 | 58 |
| Example 2 | | | | | |
| Comparative | 78 | 4 | 99 | 15 | 79 |
| Example 3 | | | | | |

### EXAMPLE 7

A multilayer ceramic capacitor was prepared in the same manner as in Example 1 except that one second internal electrode was added at the position closest to the first principal surface, and one first internal electrode was added at the position closest to the second principal surface as shown in FIG. 9.

### EXAMPLE 8

A multilayer ceramic capacitor was prepared in the same manner as in Example 1 except that between the 45th internal electrode laminated portion and the 46th internal electrode laminated portion from the first principal surface, one second internal electrode and one first internal electrode were added from the side of the first principal surface as shown in FIG. 10.

### EXAMPLE 9

A multilayer ceramic capacitor was prepared in the same manner as in Example 3 except that one second internal electrode was added at the position closest to the first principal surface, and one first internal electrode was added at the position closest to the second principal surface as shown in FIG. 9.

### EXAMPLE 10

A multilayer ceramic capacitor was prepared in the same manner as in Example 3 except that between the 11th internal electrode laminated portion and the 12th internal electrode laminated portion from the first principal surface, one second internal electrode and one first internal electrode were added from the side of the first principal surface as shown in FIG. 10.

Also for the samples prepared in Examples 7 to 10, occurrence of cracking or chipping was checked, and ESL was measured in the same manner as described above. The results are shown in Table 2.

TABLE 2

| | | | | Number of | |
|---|---|---|---|---|---|
| | | | | occurrence of | |
| | | | C | cracking or | ESL |
| | A | B | (μm) | chipping | (pH) |
| Example 7 | 3 | 90 | 5 | 0 | 35 |
| Example 8 | 3 | 90 | 8 | 0 | 36 |
| Example 9 | 12 | 22 | 16 | 0 | 35 |
| Example 10 | 12 | 22 | 18 | 0 | 40 |

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a capacitor body including first and second principal surfaces extending in a length direction and a width direction, first and second lateral surfaces extending in the length direction and a laminating direction, and first and second end surfaces extending in the width direction and the laminating direction;
a first external electrode disposed on at least one surface of the first and second lateral surfaces and the first and second end surfaces;
a second external electrode disposed on at least one surface of the first and second lateral surfaces and the first and second end surfaces, the second external electrode being disposed at a position different from a position where the first external electrode is disposed;
a first internal electrode disposed inside the capacitor body and connected with the first external electrode; and
a second internal electrode disposed inside the capacitor body and connected with the second external electrode; wherein
the capacitor body includes:
a first internal electrode laminated portion in which three or more first internal electrodes are sequentially laminated in the laminating direction; and
a second internal electrode laminated portion in which three or more second internal electrodes are sequentially laminated in the laminating direction; wherein
the second internal electrode laminated portion is opposite to the first internal electrode laminated portion in the laminating direction.

2. The multilayer ceramic capacitor according to claim 1, wherein
the capacitor body includes a plurality of the first internal electrode laminated portions and a plurality of the second internal electrode laminated portions;
a distance between the first internal electrode laminated portions adjacent in the laminating direction divided by a sum of thicknesses of the second internal electrodes and a distance between the second internal electrodes adjacent in the laminating direction is 25 or less; and
a distance between the second internal electrode laminated portions adjacent in the laminating direction divided by a sum of thicknesses of the first internal electrodes and a distance between the first internal electrodes adjacent in the laminating direction is 25 or less.

3. The multilayer ceramic capacitor according to claim 1, wherein
the capacitor body includes a plurality of the first internal electrode laminated portions and a plurality of the second internal electrode laminated portions;
each of a distance between the first internal electrode laminated portions adjacent in the laminating direction, and a distance between the second internal electrode laminated portions adjacent in the laminating direction is about 31 μm or less.

4. The multilayer ceramic capacitor according to claim 1, wherein the capacitor body includes an alternate laminated portion in which the first internal electrode and the second internal electrode are alternately laminated in the laminating direction.

5. The multilayer ceramic capacitor according to claim 1, wherein the external electrode to which the internal electrode disposed closest to the first principal surface in the capacitor body is connected is different from the external electrode to which the internal electrode adjacent in the laminating direction is connected.

6. The multilayer ceramic capacitor according to claim 1, wherein the external electrode to which the internal electrode disposed closest to the second principal surface in the capacitor body is connected is different from the external electrode to which the internal electrode adjacent in the laminating direction is connected.

7. The multilayer ceramic capacitor according to claim 1, wherein the capacitor body includes a portion where the first internal electrode laminated portion and the second internal electrode laminated portion are alternately laminated and include a total of eleven or more layers.

8. The multilayer ceramic capacitor according to claim 1, wherein the capacitor body has a rectangular or substantially rectangular parallelepiped shape.

9. The multilayer ceramic capacitor according to claim 1, wherein ridges or corners of the capacitor body have chamfered or rounded shapes.

10. The multilayer ceramic capacitor according to claim 1, wherein three of the first external electrode are provided on the capacitor body, and three of the second external electrode are provided on the capacitor body.

11. The multilayer ceramic capacitor according to claim 10, wherein each of the first external electrodes and each of the three second external electrodes is U-shaped or substantially U-shaped.

12. The multilayer ceramic capacitor according to claim 10, wherein each of the first external electrodes and each of the three second external electrodes includes a base electrode layer disposed on the capacitor body, a Ni plating layer disposed on the base electrode layer, and a Sn plating layer disposed on the Ni plating layer.

13. The multilayer ceramic capacitor according to claim 1, wherein
the capacitor body includes a plurality of the first internal electrode laminated portions and a plurality of the second internal electrode laminated portions;
a distance between the first internal electrode laminated portions adjacent in the laminating direction divided by a sum of thicknesses of the second internal electrodes and a distance between the second internal electrodes adjacent in the laminating direction is 8 or less; and
a distance between the second internal electrode laminated portions adjacent in the laminating direction divided by a sum of thicknesses of the first internal electrodes and a distance between the first internal electrodes adjacent in the laminating direction is 8 or less.

14. The multilayer ceramic capacitor according to claim 1, wherein
the capacitor body includes a plurality of the first internal electrode laminated portions and a plurality of the second internal electrode laminated portions;
each of a distance between the first internal electrode laminated portions adjacent in the laminating direction, and a distance between the second internal electrode laminated portions adjacent in the laminating direction is about 26 μm or less.

15. The multilayer ceramic capacitor according to claim 1, wherein
the capacitor body includes a plurality of the first internal electrode laminated portions and a plurality of the second internal electrode laminated portions;
each of a distance between the first internal electrode laminated portions adjacent in the laminating direction, and a distance between the second internal electrode laminated portions adjacent in the laminating direction is about 18 μm or less.
